(19) United States
(12) Patent Application Publication
(10) Pub. No.: US 2011/0208503 A1
(43) Pub. Date: Aug. 25, 2011

(54) APPARATUS AND METHOD FOR EMULATING REMOVAL AND INSERTION OF A PLUG-IN DEVICE

(76) Inventors: Michael Stritt, Oberbuchsiten (CH); Stephan Nigg, Solothurn (CH)

(21) Appl. No.: 12/673,075

(22) PCT Filed: Aug. 14, 2007
(86) PCT No.: PCT/CH07/00399

§ 371 Date: Feb. 11, 2010

(51) Int. Cl. G06G 7/62

(52) U.S. Cl. 703/21

(57) ABSTRACT

The present disclosure relates to an apparatus for emulating removal and insertion of a plug-in device, including a detection signal input and a detection signal output for a detection signal of the plug-in device, a control signal input for a control signal from a host system, and a unit which is constructed such that in a first state of the switch the detection signal input and the detection signal output are connected and in a second state of the unit the detection signal input and the detection signal output are disconnected and wherein the state of the unit depends on the control signal. The unit preferably includes a switch. The disclosure further relates to a method for emulating removal and insertion of a plug-in device wherein a control signal is applied to the control signal input of the apparatus requesting removal and insertion of the plug-in device, the detection signal input is disconnected from the detection signal output by bringing the unit into the second state and the detection signal input is connected to the detection signal output by bringing the unit into the first state.

### TECHNICAL FIELD

The invention relates to an apparatus and a method for emulating removal and insertion of a plug-in device.

By a plug-in device any external device or module is meant that can be inserted or attached to a host system. In particular so-called hot plug-in devices are meant, i.e. external devices that can be plugged in and put into operation while the host system is running. Such plug-in devices may be external cards, such as PC (Personal Computer) cards, Express Cards, or CardBus extension cards, or other external modules such as for example a digital camera or external hard disk drive. An external card may for example be needed for communicating over a mobile network or a WLAN (Wireless Local Area Network). External cards for performing other functions are also available. For the insertion of such a plug-in device a slot or another interface is provided by the host system.

By the term “insertion” is also meant the connection or the plugging in of an external device to a host system, for example the connection of an external digital camera.

By the term “host system” any informing handling system such as a personal computer, a notebook, or a PDA (Personal Digital Assistant) is meant.

### BACKGROUND

For interacting with a plug-in device usually a driver is required that is installed on the host system to which the plug-in device is connected. If the plug-in device and/or its associated driver crashes or hangs up, respectively, typically the plug-in device has to be removed physically from the host system, e.g. the computer, and then inserted again to reset or restart, respectively, the plug-in device and/or its associated driver on the host system properly. For applications where unattended stable long-term operation of the plug-in device is required physical removal and insertion of the plug-in device in case of a crash is, however, not an option. Such applications may for example be the performance of unattended long-term measurements with the plug-in device that is controlled by the host system.

### DISCLOSURE OF THE INVENTION

It is an object of the invention to provide an apparatus and a method that emulate the physical removal and insertion of a plug-in device, in particular an external card, so that manual interactions by a user or an entire reboot of the host system are not required for restarting the plug-in device or its associated driver on the host system.

In order to implement these and still further objects of the invention, which will become more readily apparent as the description proceeds, an apparatus for emulating removal and insertion of a plug-in device is provided, that comprises a detection signal input and a detection signal output for a detection signal of the plug-in device, a control signal input for a control signal of a host system, and a unit which is constructed such that in a first state of the unit the detection signal input and the detection signal output are connected and in a second state of the unit the detection signal input and the detection signal output are disconnected. The state of the unit depends on the control signal of the host system. The unit preferably comprises a switch, with the first state of the unit corresponding to a closed state of the switch and the second state of the unit corresponding to an open state of the switch. In the closed state of the switch the detection signal input and the detection signal output are connected and in the open state of the switch the detection signal input and the detection signal output are disconnected. The unit most preferably is formed as such a switch. The state of the switch, which may also be called position of the switch, is controlled by the control signal of the host system. The switch may be represented by a corresponding electrical circuit or logic. The switch may also be called line breaker. The unit may also be formed as a mechanical device which is constructed such that is can eject and insert the plug-in device.

The terms “input” and “output” refer to physical input and output ports for inputting and outputting a signal, respectively. A detection signal as defined herein may comprise several detection signals.

Furthermore, a method for emulating removal and insertion of a plug-in device is provided, wherein a control signal is applied to the control signal input of the apparatus according to the invention, the control signal requesting plug-in device removal and insertion. The detection signal input is upon receipt of the control signal disconnected from the detection signal output by bringing the unit into the second state and the detection signal input is afterwards again connected with the detection signal output by bringing the unit into the first state. The unit preferably comprises a switch or is formed as a switch and the unit is preferentially brought into the second state by opening the switch, i.e. by bringing the switch into the open state, and the unit is preferentially brought into the first state by closing the switch, i.e. by bringing the switch into the closed state.

A host system such as a computer usually detects a properly inserted plug-in device by receipt of a detection signal that is transmitted from the plug-in device to the host system. If the detection signal is not received, the plug-in device is not detected by a corresponding processing unit of the host system. The apparatus according to the invention is positioned within the signaling path of the detection signal from the plug-in device to the processing unit of the host system. By positioning the apparatus within the signaling path of the detection signal, the signaling path is provided with a unit that is constructed such that in a first state the detection signal input and the detection signal output are connected and in a second state the detection signal input and the detection signal output are disconnected, namely the unit of the apparatus which preferably comprises or is formed as a switch. If the host system detects hanging up of either the plug-in device or its associated driver it sends a corresponding control signal to the apparatus leading to the unit being brought into second state, preferably to an opening of the switch, such that the signaling path of the detection signal between the plug-in device and the processing unit of the host system is interrupted and afterwards to the unit being brought into the first state, preferably to a closing of the switch, and thereby re-establishing of the signaling path which emulates physical removal and insertion of the plug-in device resulting in a restart of the plug-in device and/or its associated driver on the host system.

The host system may for example be informed about the crashing of the plug-in device or its associated driver by an application program installed on the host system that uses the plug-in device and sends a corresponding message to the processing unit which then generates the control signal for the apparatus according to the invention.

The signaling path of the detection signal, on which the apparatus according to the invention shall be arranged, is preferably aimed at transmitting the detection signal and not used for supplying the plug-in device with electrical energy. However, embodiments of the apparatus are possible, wherein the apparatus can be positioned within a signaling path that also serves for supplying electrical energy from the host system to the plug-in device.

The apparatus according to the invention can be integrated into the host system, i.e. it can be constructed such that it is mountable within the host system, in particular within a computer, for example mountable on a motherboard of a computer. If the apparatus according to the invention shall be integrated into a host system it is preferably constructed such that it can be easily built into an existing host system.

Alternatively, the apparatus according to the invention can form a separate unit, i.e. a unit that is formed separately from the host system. In the later case the apparatus preferably comprises an adapter for connection with the plug-in device and for connection with the host system, the adapter comprising the detection signal input on the side associated with the plug-in device and the detection signal output on the side associated with the host system. If the apparatus is formed separately from the host system it further preferably comprises a connector for connecting with a communication interface of the host system, wherein the connector comprises a control signal input for receiving a control signal from the host system. The communication interface to which the connector can be connected can for example be a serial interface, a parallel interface or a USB (Universal Serial Bus) port. If a USB port is used as communication interface then the connector is accordingly formed as USB plug. The unit, in particular the switch, of the apparatus can either form part of the adapter or part of the connector.

### BRIEF DESCRIPTION OF THE DRAWINGS

Further advantageous features and applications of the invention can be found in the depending claims as well as in the following description of the drawings illustrating the invention. In the drawings like reference signs designate the same or similar parts throughout the several figures of which:

FIG. 1 shows a block diagram of a host system, a plug-in device and a first embodiment of an apparatus according to the invention,

FIG. 2 shows a block diagram of a host system, a plug-in device and a second embodiment of an apparatus according to the invention,

FIG. 3 shows a schematic perspective representation of a plug-in device in form of an external card and the second embodiment of the apparatus according to the invention, and

FIG. 4 shows a layered representation of a host system, a plug-in device and an apparatus according to the invention.

### MODES FOR CARRYING OUT THE INVENTION

FIG. 1 shows an external plug-in device 1, in particular a hot plug-in device, which is connected to a host system 2, in particular a personal computer-based system, with the central processing unit 3. The plug-in device 1 is connected to the central processing unit 3 of the host system 2 via a communication interface 4 by exemplary three lines 6, 7 and 8, the communication interface 4 being located within the three lines 6, 7, 8. Of course, there can be more than three lines provided. Lines 7 and 8 preferably each represent a multiple line (highway)/bus (as indicated by the crossing lines through lines 7 and 8). Line 7 serves as a multiple line for example for supplying electrical energy from the host system 2 to the plug-in device 1. Line 8 may e.g. serve as control bus/data bus. Line 6 serves as detection line for transmitting a detection signal from the plug-in device 1 to the host system 2, i.e. its central processing unit 3, indicating to the host system 2 that the plug-in device 1 has been connected or inserted, respectively. Of course, detection line 6 may also be formed as multiple line for the transmission of several detection signals. An apparatus 9 for emulating removal and insertion of the plug-in device 1 is provided that comprises a detection signal input 10, a detection signal output 11 and a switch 12 located between the detection signal input 10 and the detection signal output 11. In a closed state of the switch 12 the detection signal input 10 is connected to the detection signal output 11. The switch 12 is preferably an on-off-switch, for example, a relay.

In the embodiment depicted in FIG. 1 the apparatus 9 is integrated into the host system 2, in particular the apparatus 9 is mounted on a mother board (not depicted) of the host system 2. The apparatus 9 is positioned within the detection line 6 between the communication interface 4, to which the plug-in device 1 is connected, and the central processing unit 3 of the host system. For controlling the switch 12 the apparatus 9 has a control signal input 13 through which it can receive a control signal from the host system 2, in particular from its central processing unit 3. Preferably the apparatus 9 comprises a control unit 14 for interpreting the control signal sent from the host system 2 and for controlling the switch 12 in response to this control signal. Hence, if the host system detects or is by an application/application program informed about the crash or failure of the plug-in device 1 or its associated driver then—for emulating removal and insertion of the plug-in device 1—it sends a corresponding control signal to the apparatus 9 which opens the switch 12 and after that closes the switch 12 to restart the plug-in device 1 and its associated driver, respectively. Manual removal of the plug-in device 1 is not required.

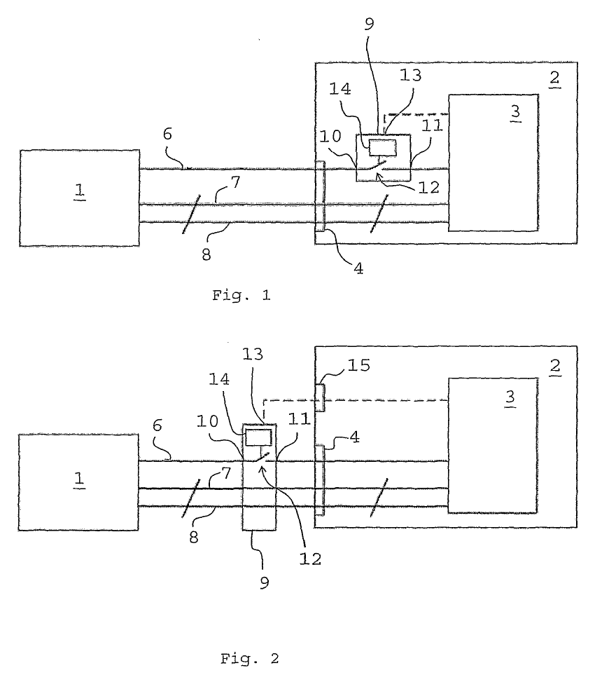

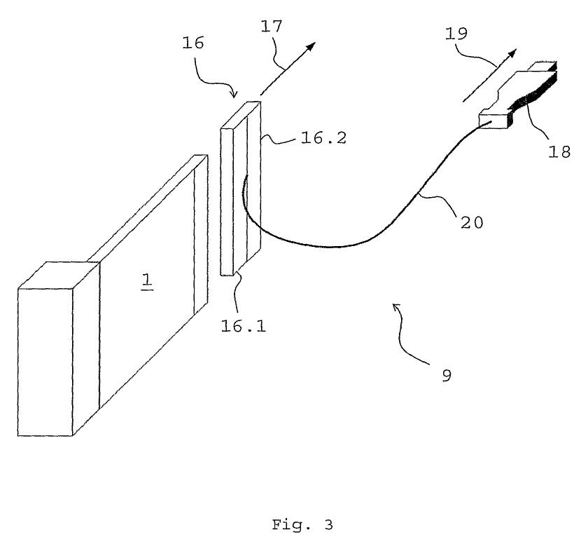

FIG. 2 depicts a block diagram as shown in FIG. 1 but with the apparatus 9 for emulating removal and insertion of a plug-in device forming a separate unit that is located outside the host system 2. The apparatus 9 is preferentially provided with a housing. For receiving the control signal the apparatus 9 is connected to a second communication interface 15, preferably a USB port, which is connected to the central processing unit 3 of the host system 2 which sends the control signal. Of course a serial interface, a parallel interface or a similar interface may also be used as communication interface 15 for transmitting the control signal to the apparatus 9.

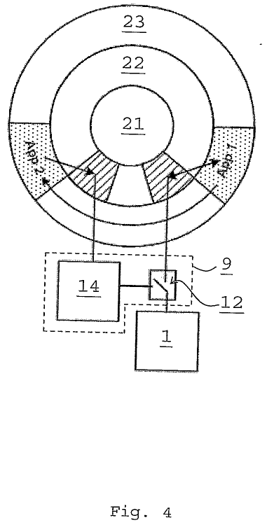

FIG. 3 shows the embodiment of the apparatus 9 as depicted in FIG. 2 and a plug-in device 1 in form of an external PC card in schematic, exploded view. The apparatus 9 comprises an adapter 16 with a first adapter part 16.1 for connection with the plug-in device 1 and a second adapter part 16.2 for connection with the host system (symbolized by arrow 17). The host system 2 comprises a slot (not shown) into which the adapter 16 of the apparatus 9 and the plug-in device 1 both are inserted. Lines 7 and 8 for supplying electrical energy to the plug-in device 1 have counterparts in the adapter 16 for ensuring supply of electrical energy.

The apparatus 9 furthermore comprises a connector 18 for connection with the second communication interface 15 of the host system 2 (confer FIG. 2) through which the control signal is transmitted to the apparatus 9. Exemplarily the connector 18 is formed as a USB plug, the second communication interface 15 then being formed as USB port (not shown). The connection to the second communication interface 15 is indicated by arrow 19.

Connector 18 and adapter 16 are connected through a line 20. The switch 12 and/or the control unit 14 (confer FIG. 2) may be located either in the adapter 16 or in the connector 18. If the switch 12 is located in the connector 18 then the detection signal is transmitted from the adapter part 16.1 via line 20 to the switch 12 inside the connector 18 and—if the switch 12 is in the closed state—through line 20 to adapter part 16.2 and from the adapter part 16.2 to the host system 2 via the communication interface 4 (confer FIG. 2). If the switch 12 is located inside the adapter 16 and either no additional control unit 14 is provided or the control unit 14 is also integrated into the adapter 16, then line 20 only serves for the transmission of the control signal from the host system 2 to the adapter 16. If the control unit 14 is located in the connector 18 and the switch 12 is located in the adapter 16 then line 20 serves for transmission of a signal from the control unit 14 to the switch 12.

In the case of the plug-in device 1 being an external card as shown in FIG. 3 its shortest pins serve as card detection pins forming the detection line 6 together with the apparatus 9 and the host system 2. In case of the plug-in device 1 being a USB device, for example a USB camera, its two shortest pins, also called D+ and D−, serve as detection pins forming, amongst others, the detection line 6.

FIG. 4 shows exemplarily a layered representation of a host system, to which a plug-in device 1 is connected via an apparatus 9 according to the invention. On the host systems an operating system with a kernel 21 is implemented. The kernel 21 is responsible of loading, controlling and unloading drivers if required. The drivers are represented in FIG. 4 by a driver layer 22. Various applications may be run by the host system which is represented by an application layer 23. The applications 23 are driven via drivers 22 by the kernel 21.

For example, a main application App 1 may run on the host system which makes use of the plug-in device 1, e.g. for taking data measurements. If the application App 1 detects that the plug-in device 1 or its associated driver has crashed it informs an auxiliary application program App 2 about this crash. The auxiliary application program App 2 is a particular application program for controlling the apparatus 9. It causes the emulation of the removal and insertion of the plug-in device 1 by initiating the transmission of a corresponding control signal to the apparatus 9. This induces the emulation of the removal of the plug-in device 1 by opening the switch 12 through the control unit 14. After a certain amount of time has lapsed, which basically corresponds to the time that the operating system and its kernel 21, respectively, need for unloading the driver associated with the plug-in device 1, the emulation of the insertion of the plug-in device is performed by closing the switch 12. The emulation of the removal and insertion of the plug-in device 1 corresponds to restarting the plug-in device 1 and reloading the driver associated with it.

There may be a particular program installed on the host system that permanently runs in the background (so-called daemon program) that surveys the plug-in device 1 and its associated driver in order to detect if either one crashes whereupon it informs the auxiliary application program APP 2 which then initiates the emulation of the removal and insertion of the plug-in device 1 through the apparatus 9.

It is to be understood that while certain embodiments of the present invention have been illustrated and described herein, it is not to be limited to the specific embodiments described and shown.

1. An apparatus for emulating removal and insertion of a plug-in device, comprising:
a detection signal input and a detection signal output for a detection signal of the plug-in device,
a control signal input for a control signal from a host system,
a unit which is constructed such that in a first state of the unit the detection signal input and the detection signal output are connected and in a second state of the unit the detection signal input and the detection signal output are disconnected, and
wherein the state of the unit depends on the control signal.

2. The apparatus according to claim 1, wherein the unit comprises a switch and the first state of the unit corresponds to a closed state of the switch and the second state of the unit corresponds to an open state of the switch.

3. The apparatus according to claim 1, further comprising an adapter for connection with the plug-in device and the host system, the adapter comprising the detection signal input and the detection signal output.

4. The apparatus according to claim 1, further comprising a connector for connecting with a communication interface, in particular a USB port, of the host system, the connector comprising the control signal input.

5. The apparatus according to claim 3, wherein the switch is part of the adapter or of the connector.

6. The apparatus according to claim 1, wherein the apparatus is mountable within the host system, in particular within a computer.

7. The apparatus according to claim 1, wherein a control unit is provided for interpreting the control signal and for controlling the switch in response to the control signal.

8. Host system with an apparatus according to claim 1.

9. A method for emulating removal and insertion of a plug-in device with an apparatus according to claim 1, comprising:
applying a control signal to the control signal input of the apparatus requesting removal and insertion of the plug-in device,
disconnecting the detection signal input from the detection signal output by bringing the unit into the second state
connecting the detection signal input to the detection signal output by bringing the unit into the first state.

10. The method according to claim 9, wherein the unit is brought into the second state by opening a switch and wherein the unit is brought into the first state by closing the switch.

11. The method according to claim 9, wherein the unit is controlled by a control unit that interprets the control signal and controls the unit in response to the control signal.
